(19) United States
(12) Patent Application Publication
(10) Pub. No.: US 2005/0149682 A1
(43) Pub. Date: Jul. 7, 2005

(54) Virtual multiple removable media jukebox

(76) Inventor: Han-Gyoo Kim, Irvine, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/029,775

(22) Filed: Jan. 5, 2005

Related U.S. Application Data
(63) Continuation-in-part of application No. 09/974,082, filed on Oct. 9, 2001.
(63) Continuation-in-part of application No. 10/195,817, filed on Jul. 15, 2002.
(60) Provisional application No. 60/534,508, filed on Jan. 5, 2004.
(60) Provisional application No. 60/603,917, filed on Aug. 23, 2004.
(60) Provisional application No. 60/590,722, filed on Jul. 22, 2004.

(51) Int. Cl. G06F 13/00; G06F 15/16

(52) U.S. Cl. 711/161; 711/173; 709/217

(57) ABSTRACT

A virtual jukebox providing access to data content of a removable medium, such as a compact disc or digital versatile disc. In one embodiment, the jukebox includes a removable media drive, as well as a hard disk drive in communication with the removable media and a host. The removable media drive stores to the hard disk drive the data contents of a removable medium loaded into the removable media drive. The hard disk drive provides the host access to the data content stored on the hard disk drive by way of a logical view of a virtual removable media drive loaded with the removable medium. The virtual jukebox may be coupled with the host by way of the host system bus, or a network coupled with the host. In an alternative embodiment, the virtual jukebox is implemented as a standalone unit.

### CROSS-REFERENCE TO RELATED APPLICATIONS

This application claims the benefit of U.S. Provisional Application Ser. No. 60/534,508, entitled “Virtual Multi-CD/DVD Jukebox Using Hard Disk with Networking Capability” and filed Jan. 5, 2004; U.S. patent application Ser. No. 09/974,082, entitled “Disk System Adapted to Be Directly Attached to Network” and filed Oct. 9, 2001; U.S. Provisional Patent Application Ser. No. 60/603,917, entitled “A Network Direct Attached Storage Suitable for Home Network,” filed Aug. 23, 2004; U.S. Nonprovisional Patent Application Ser. No. 10/195,817, entitled “Scheme for Dynamically Connecting I/O Devices Through Network” and filed on Jul. 15, 2002; and U.S. Provisional Application Ser. No. 60/590,722, entitled “Low Level Communication Layers and Device Employing Same” and filed on Jul. 22, 2004; all of which are hereby incorporated by reference as if fully set forth herein.

### BACKGROUND OF THE INVENTION

a. Field of the Invention

The invention relates generally to removable storage media drives, and more particularly to compact disc (CD)/digital versatile disc (DVD) jukeboxes or changers providing electronic access to multiple CDs and/or DVDs.

b. Background of the Invention

CD and DVD drives typically allow access by a host to a single CD or DVD (more generally, a “disc”) which has been loaded into the drive. Generally, hosts, as referred to herein, are electronic devices that employ data storage devices to store digital data for later retrieval and processing by the host. Hosts include, but are not limited to, computers (including desktop personal computers, laptop personal computers and workstations), personal digital assistants (PDAs), digital audio systems, digital television sets, television set-top boxes, digital game devices, smart phones, hand-held computing devices, portable digital music devices (such as an MPEG-3, MPEG-4 and/or AAC player, and so forth) and other digital data processing devices.

To allow access to information residing on several CDs or DVDs, disc changers or jukeboxes, typically incorporating storage for several discs, provide one or more CD and/or DVD drives (“CD/DVD drives”) accessible by a host. Access by the host to a jukebox is often facilitated by a server coupled therebetween. Each of the stored discs may be potentially loaded into or unloaded from one or more of the drives by way of one or more mechanical arms. When a host requests access to a particular disc which is not currently loaded into one of the jukebox drives, a motorized mechanical arm of the jukebox removes a currently loaded disc from a drive (if necessary), returns the previously loaded disc to storage, retrieves the requested disc from storage, and places the requested disc into the empty drive. Once the requested disc has been loaded and recognized by the drive, the host may then access the particular information requested. Subsequent disc accesses are performed in a similar manner. Thus, one or a few CD/DVD drives may provide a host reasonable access to a large number of discs without direct human intervention.

However, due to the mechanical arm and related electronics, as well as the possible use of multiple CD/DVD drives, jukeboxes are often large, heavy, complex machines that are potentially expensive and difficult to maintain. Also, serving requests for information residing on unloaded discs is typically slow, due to the time normally required for the mechanical arm to load a disc. Further, loading of the disc may be delayed while a previous access request for a loaded disc is being completed. Even if accesses from two different hosts both involve the same loaded disc, satisfying one request before another is processed may require a significant period of time due to the data rates normally provided by CD/DVD drives, especially when compared to magnetic hard disk drives. Further, certain commands typically issued to a CD/DVD drive by a computer or other host cannot be processed by the drive and service to multiple hosts simultaneously. For example, most CD/DVD drives cannot play data or music from a disk therein to more than a single host simultaneously, if the play command is implemented through the ATAPI (“ATA attachment packet interface”) interface.

Also currently available are virtual CD/DVD players, which are essentially host-resident application programs which copy the contents of a CD or DVD onto a hard disk drive. Thus, the information from several CDs or DVDs may coexist on a hard disk drive for subsequent retrieval by the host executing the virtual CD/DVD player. However, the virtual player recognizes the hard disk drive as a hard disk drive, as opposed to a CD/DVD player, when retrieving the previously-copied data. As a result, host accesses of the CD/DVD information on the hard disk drive must be performed via the virtual CD/DVD player at the application level, instead of through the host file system as a CD/DVD player or jukebox.

Given the foregoing, a system providing the primary functionality of a CD, DVD, or other removable storage media jukebox while delivering enhanced performance and reduced cost would be advantageous.

### BRIEF SUMMARY OF THE INVENTION

Generally, embodiments of the present invention provide a virtual jukebox for accessing removable media, such as a CD or DVD. In one embodiment, the jukebox includes a removable media drive, as well as a hard disk drive in communication with the removable media drive and a host, such as a computer or other device, as noted earlier. The removable media drive stores to the hard disk drive the data contents of a removable medium loaded into the removable media drive. The hard disk drive provides the host access to the data content stored on the hard disk drive by way of a logical view of a virtual removable media drive loaded with the removable medium. Thus, the host views the hard disk drive as multiple, logical, removable media drives, each of which is loaded with a removable medium, such as a CD or DVD. Depending on the nature of the removable medium, host access may be read-only, or both read and write accesses may be permitted.

In one embodiment of the invention, the virtual jukebox is coupled with the host by way of the host system bus. The virtual jukebox may be coupled with the system through a device controller, such as a standard disk drive controller. Further, the host may employ a device driver that translates access commands for a CD/DVD drive to hard disk drive commands understandable by the device controller.

For example, many CD/DVD drives and hard disk drives installed in modern computers employ the same interface, namely the EIDE (“enhanced integrated drive electronics”) interface. Commands issued to a hard disk drive are typically AT commands, while commands issued using the EIDE interface to a CD/DVD drive are ATAPI commands. Generally speaking, ATAPI commands make up an extended command set having extra hard disk functionality and new functionality for interacting with CD/DVD drives. Accordingly, many modern computers' CD/DVD drives share a device controller with a hard disk drive.

By contrast, the present embodiment employs a different device driver and/or software to translate ATAPI commands intended for a CD/DVD drive into commands intended for a hard disk drive. The device driver may, for example, include some form of a table performing a one-to-one conversion of commands. Continuing the example, a data retrieval command intended for a CD/DVD drive may be converted by the present embodiment into a read command for a hard disk drive. Further, the present embodiment may convert such commands not only to an EIDE-compatible command suitable for accessing a local hard disk drive, but alternately to a command employing or configured with a network protocol suitable to access a remote hard drive across a network. The network may be, for example, the Internet, an intranet, a local-are network (LAN), wide-area network (WAN), Ethernet, wireless network, wired network, and so forth.

In another embodiment, the virtual jukebox is coupled with at least one host by way of a network. A network device controller may be employed to couple the virtual jukebox with the network.

In an alternative embodiment, the virtual jukebox is implemented as a standalone unit employing a user interface, whereby a user may gain access to the data content of the hard disk drive transferred from a removable medium.

Embodiments of the invention may also take the form of a method for providing access to data content of a removable medium. Generally, the data content is read from the removable medium and stored onto a hard disk drive. Subsequently, requests for access to the data content of the medium are serviced by providing access to the data content residing on the hard disk drive by way of a logical view of the data content as stored on the removable medium.

Additional embodiments and advantages of the invention will be realized by those skilled in the art upon reading the detailed description of the invention, provided below.

### BRIEF DESCRIPTION OF THE DRAWINGS

FIG. 1A depicts a simplified physical view of a virtual jukebox, according to a first embodiment of the invention, incorporating a CD/DVD drive and a hard disk drive.

FIG. 1B depicts a simplified logical view of the virtual jukebox of FIG. 1A as a collection of CD/DVD drives.

FIG. 2 depicts a logical view of the hard disk drive of FIG. 1 showing sequential groups of data sectors, with each group representing a virtual CD/DVD drive.

FIG. 3 depicts a simplified physical mapping between a CD/DVD disc and a hard disk platter according to an embodiment of the invention.

FIG. 4 depicts a block diagram of a host and incorporated software hierarchy coupled with a virtual jukebox, according to a second embodiment of the invention.

FIG. 5 depicts a flow diagram of the operation of a device driver stack of the host shown in FIG. 4.

FIG. 6 depicts a block diagram of multiple hosts coupled with a virtual jukebox according an embodiment of the invention by way of a network device controller.

FIG. 7 depicts a standalone virtual jukebox according to an embodiment of the invention.

### DETAILED DESCRIPTION OF THE INVENTION

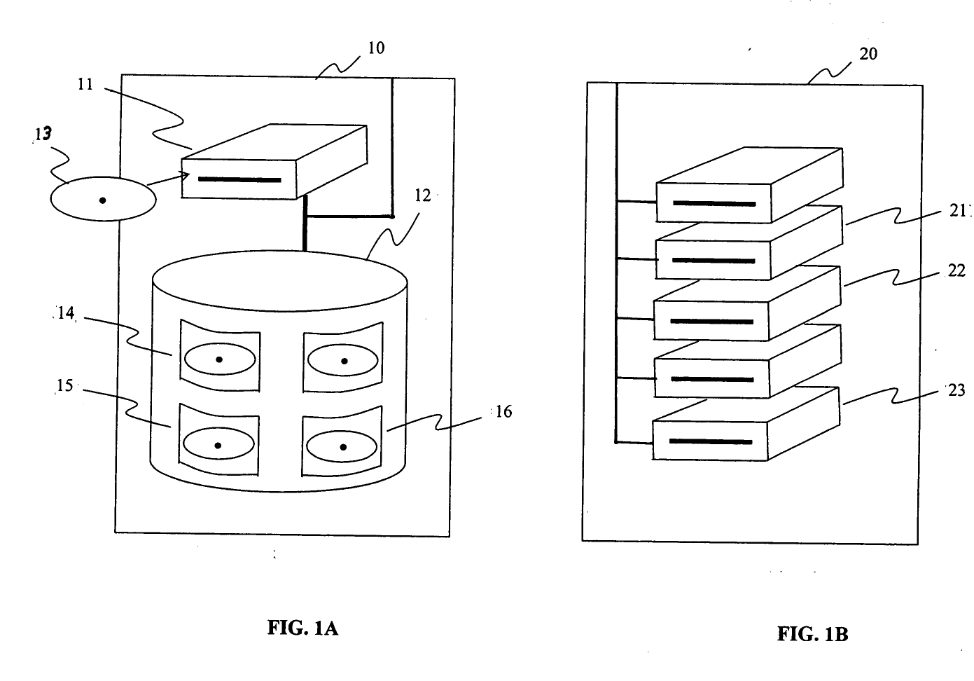

A simplified physical representation of a virtual CD/DVD jukebox 10, according to one embodiment of the invention, is illustrated in FIG. 1A. The jukebox 10 contains a CD/DVD drive 11 coupled with a hard disk drive 12, such as a magnetic disk drive. More than one CD/DVD drive and/or more than one hard disk drive 12 may be employed in alternative embodiments, although an embodiment employing a single CD/DVD drive 11 and a single hard disk drive 12 may represent a particularly cost-effective implementation. Neither mechanical arms nor disc storage space is required, unlike the standard CD/DVD jukeboxes discussed above. Instead, any CD or DVD 13 that is to be accessible by a host is loaded into the CD/DVD drive 11, which reads the information from the disc 13 and writes the information to a sector group 14, 15, 16 of the hard disk drive 12. Once the disc 13 has been copied onto the hard disk drive 12, subsequent accesses from a host coupled with the jukebox 10 are directed to the sector group 14, 15, 16 of the hard disk drive 12 associated with the disc 13 the host wishes to access.

For discs that are intended to be read only, only read accesses by the host are typically permitted. For writable or rewritable discs, such as those manufactured for use with the DVD+RW or DVD-RW rewritable DVD formats, both reading and writing of the sector group 14, 15, 16 is allowed.

The data content from a disc 13 that is copied to the hard disk drive 12 may represent any data normally stored on such a disc 13, including, but not limited to, digital audio data (such as that which may be found on an audio CD), combined audio/video data (such as that normally found on a DVD), video graphics files, and/or computer-readable data associated with document files, spreadsheets, databases, and myriad other types of information.

The virtual jukebox 10 shown in FIG. 1A provides several advantages. Since each CD/DVD disc 13 inserted by a user into the CD/DVD drive 11 is stored onto the hard disk drive 12, up to the data capacity of the hard disk drive 12, each CD or DVD disc 13 to be accessed need be loaded into the CD/DVD drive 13 but once. Thus, neither a mechanical arm nor extensive physical storage space for CDs and/or DVDs need be provided by the virtual jukebox 10, as all host access to the information from the CD/DVD disc 13 is directed toward the hard disk drive 12. The use of more than one CD/DVD drive, as is sometimes employed in jukeboxes of the prior art, is not required in embodiments of the present invention. Thus, such a configuration allows a smaller, lighter, and likely more easily maintained, device when compared to typical jukeboxes. Accordingly, a virtual jukebox, according to embodiments of the present invention, may allow portable implementations heretofore not contemplated.

Storing information from the CD/DVD disc 13 onto the hard disk drive 12 in such a manner typically allows much faster data access of the information by the host since hard disk drive 12 accesses are generally quicker than accessing a CD/DVD drive. Such faster access may also allow timely accesses from multiple hosts coupled with the virtual jukebox 10, as described in greater detail below.

While the virtual jukebox 10 of FIG. 1A contains one CD/DVD drive 11 and one hard disk drive 12, the logical view 20 of the virtual jukebox 10 from the perspective of a host resembles the depiction of FIG. 1B of multiple CD/DVD drives 21, 22, 23, each of which holds a logical CD or DVD disc accessible by a host. In other words, each sector group 14, 15, 16 of the hard disk drive 12, each of which holds information previously read from a separate disc 13 by way of the physical CD/DVD drive 11, is viewed by the host as a separate, logical, virtual CD/DVD drive 21, 22, 23 loaded with an associated disc 13. Therefore, the virtual jukebox 10 only requires a single CD/DVD drive 11 and one hard disk drive 12 to appear to a host as tens or hundreds of CD/DVD drives, each loaded with a disc 13.

To prevent accesses by a host to one logical drive 21, 22, 23 from adversely affecting other logical drives 21, 22, 23 as stored on the hard disk drive 12, a mutually exclusive one-to-one mapping between a hard disk drive sector group 14, 15, 16 and its associated logical CD/DVD drive 21, 22, 23 is implemented. This prevents any information overlap of the logical drives 21, 22, 23. As a result, the multiple virtual drives 21, 22, 23 may be separately enumerated for conventional CD/DVD file system software, such as that found in File Access Table (FAT), Windows NT File System (NTFS), Unix file systems, and the like. Further, the information for each virtual drive 21, 22, 23, is stored as a set of ordinary CD/DVD files.

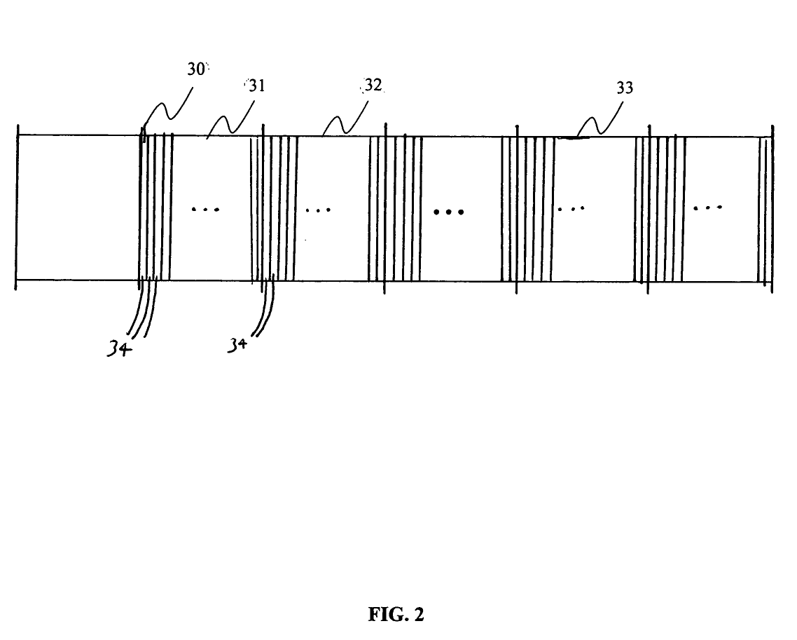

FIG. 2 provides a logical view of the sectors of the hard disk drive 12, arranged as a linear array. Beginning with a base sector 30, the data sectors of the hard disk drive 12 are organized as contiguous sector groups 31, 32, 33, wherein each group contains a number of sectors 34 providing sufficient data capacity to store the content of the CD/DVD disc corresponding to the sector in question. Thus, each sector group 31, 32, 33 corresponds to a logical CD/DVD drive 21, 22, 23 (as shown in FIG. 1B) to be accessed by a host. In an alternative embodiment, each sector group representing a CD/DVD drive need not be contiguous, but may be composed of various sectors 34 located about the hard disk drive 12.

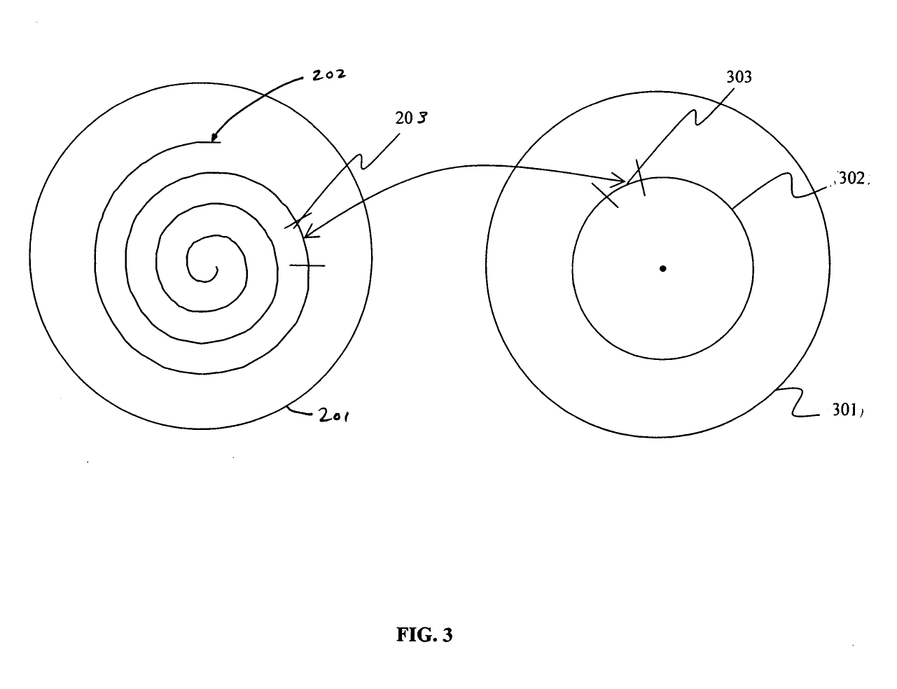

FIG. 3 illustrates the relationship between a physical CD or DVD data sector 203 within a track 202 of a CD or DVD disc 201, and a physical hard disk drive data sector 303 within a track 302 of a hard disk recording surface, or platter 301. As shown in FIG. 3, CD and DVD discs 201 employ long spiral physical tracks, while hard disk drives 301 typically utilize many concentric tracks. In this particular implementation, the data size of the hard disk drive sector 303 matches the data size of the CD or DVD data sector 203. In other embodiments, the sizes of the CD/DVD data sector and the hard disk drive sector may be different, thus requiring a mapping of several hard disk drive sectors to a single CD/DVD data sector, or vice versa. For example, if a DVD disc employs sectors holding 2 kilobytes (KB) of data, and a hard disk drive data sector holds 512 data bytes, four hard disk drive sectors would be required for each DVD disc data sector to be stored.

In an alternative embodiment of the invention, instead of copying information from the loaded disc 13 to the hard disk drive 12 verbatim, the data content from the disc 13 may be transformed into another form of data that substantially represents the information stored on the disc 13 prior to writing the information to the hard disk drive 12. More specifically, data from the disc 13 may be compressed by a hardware or software data compressor within the virtual jukebox 10 prior to being written to the hard disk drive 12. For example, audio tracks on CDs may be converted to smaller, compressed Moving Picture Experts Group-1—Audio Layer 3 (MP3) or Audio Layer 4 (MP4) audio files by an appropriate converter before being stored on the hard disk drive 12, thus allowing the hard disk drive 12 to allocate less space for the sector group associated with the disc 12. Similarly, video segments on DVDs may be converted to a lower video resolution (such as MPEG-2 or Apple's QUICKTIME format) by a video resolution converter, thus requiring less storage space when written onto the hard disk drive 12.

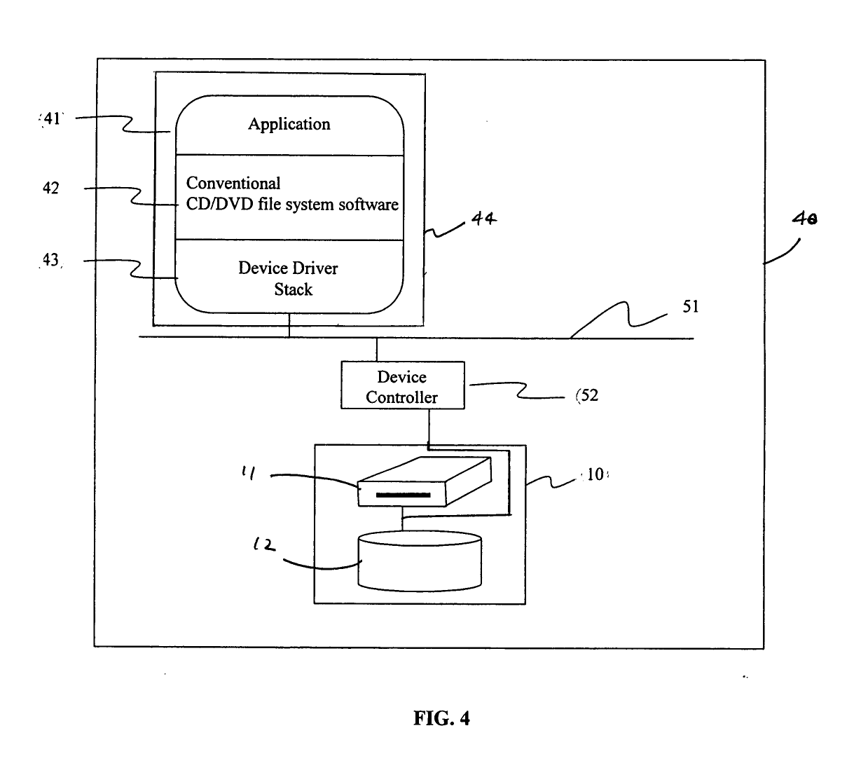

In one embodiment, the virtual jukebox 10 resides within a host 40, as shown in FIG. 4. The virtual jukebox 10 may reside within the same physical enclosure (not shown) as the host 40, or in a separate enclosure. The virtual jukebox 10 is accessed within the host over a system bus 51 by way of a device controller 52. Normally, the device controller 52 is adapted to connect the hard disk drive 12 to the system bus 51, mapping commands received from the bus 51 to a disk-related interface, such as AT Attachment (ATA), ATA Packet Interface (ATAPI), Small Computer System Interface (SCSI), or another interface utilized by the hard disk drive 12. In the present embodiment, software executing on a processor 44 of the host 40 typically includes an application 41 and conventional CD/DVD file system software 42 with a device driver stack 43. The device driver stack 43 enumerates the sector groups 14, 15, 16 (shown in FIG. 1A) as independent virtual CD/DVD drive 21, 22, 23 (shown in FIG. 1B) so that the CD/DVD file system software 42 recognizes the sector groups 14, 15, 16 as virtual CD/DVD drives 21, 22, 23. It should be noted that some embodiments of the present invention may require no software beyond the device driver, while other embodiments may implement any of the aforementioned software elements as hardware or firmware.

When the application 41 issues a command to the virtual jukebox 10 to write information to a CD/DVD disc 13 or to read information from a CD/DVD disc 13, the virtual jukebox 10 transfers information between the application 41 and the hard disk drive 12, instead of between the application and the CD/DVD disc. From the perspective of the application 41, however, data is being written to or read from one of the multiple, independent virtual CD/DVD drives 21, 22, 23 corresponding to the associated sector groups 14, 15, 16 of the hard disk drive 12.

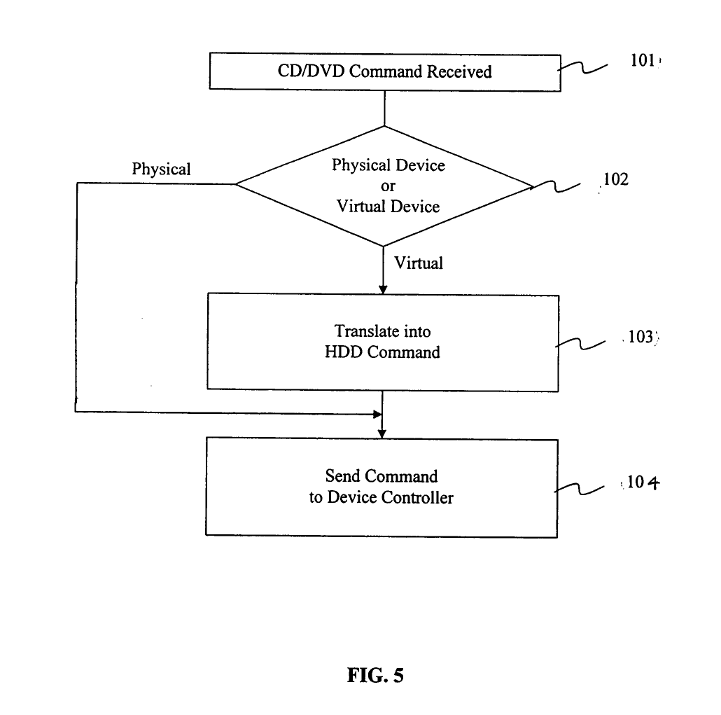

FIG. 5 illustrates one example of the operations performed by the device driver stack 43 of FIG. 4. In operation 101, a CD/DVD access command from the application 41 is received by the device driver stack 43 via the file system 42. The embodiment determines in operation 102 whether the CD/DVD device for which the command is intended is virtual or physical in operation 102. If the targeted device is virtual, in operation 103 device driver stack 43 translates the CD/DVD command into a command for the hard disk drive 12. The translated command is then sent to the device controller 52 in operation 104 for ultimate transfer to the hard disk drive 12. If, instead, the command received by the device driver stack 43 is related to a physical device, i.e., a CD/DVD drive, (not shown in FIG. 4) coupled with the device controller 52, the command is transferred to the device controller 52 as is in operation 104. As a result, due to the operation of device driver stack 43, the virtual jukebox 10 is viewed logically as multiple, independent, virtual CD/DVD drives, as opposed to a conventional CD/DVD drive coupled with a hard disk drive.

A discussion of the operation of the device driver stack 43 may prove useful. In the present embodiment, the file system 42 generally views all files, titles, or other data resident on a virtual jukebox 10 as standard, local CD/DVD data. By “local,” it is meant that the file system 42 views the data as stored on a storage device connected to the host by a local bus. Accordingly, the file system 42 generally issues access commands to the virtual jukebox 10 that are identical to those issued to a local CD/DVD drive.

Upon receiving commands from the file system 42 specifying data located on the virtual jukebox 10, the device driver stack 43 determines whether the files/titles/data are stored on the CD/DVD drive media, or are loaded on the virtual jukebox 10 (as discussed with respect to operation 102). The device driver stack 43 converts the incoming file system command to an outgoing hard disk-appropriate command if the files/titles/data are located on the virtual jukebox 10 (as mentioned with respect to operation 103).

The translation of commands from a CD/DVD command to a hard disk command, even one employing a network protocol to connect to remotely-located storage devices, is performed by the device driver stack 43. For example, the driver may translate ATAPI commands intended for a CD/DVD drive into commands intended for a hard disk drive. The device driver may, for example, include some form of a table performing a one-to-one conversion of commands. Continuing the example, a data retrieval command intended for a CD/DVD drive may be converted by the present embodiment into a read command for a hard disk drive. Further, the present embodiment may convert such commands not only to an EIDE-compatible command suitable for accessing a local hard disk drive, but alternately to a command employing or configured with a network protocol suitable to access a remote hard drive across a network. The network may be, for example, the Internet, an intranet, a local-are network (LAN), wide-area network (WAN), Ethernet, wireless network, wired network, and so forth.

In yet a further example of such command translation, most CD/DVD drives recognize the READ(10) and READ(12) ATAPI commands, which are commands to play content on media loaded into the drive. These commands are not generally defined for hard disks under the ATAPI interface. However, the READ(10) and (12) commands contain starting logical addresses and transfer lengths, indicating the start point and total size of the data to be transferred. Upon receiving a READ(10) or READ(12) command, the device driver may translate it to a series of corresponding hard disk drive commands (ATA commands) if the title is on the hard disk drive surface.

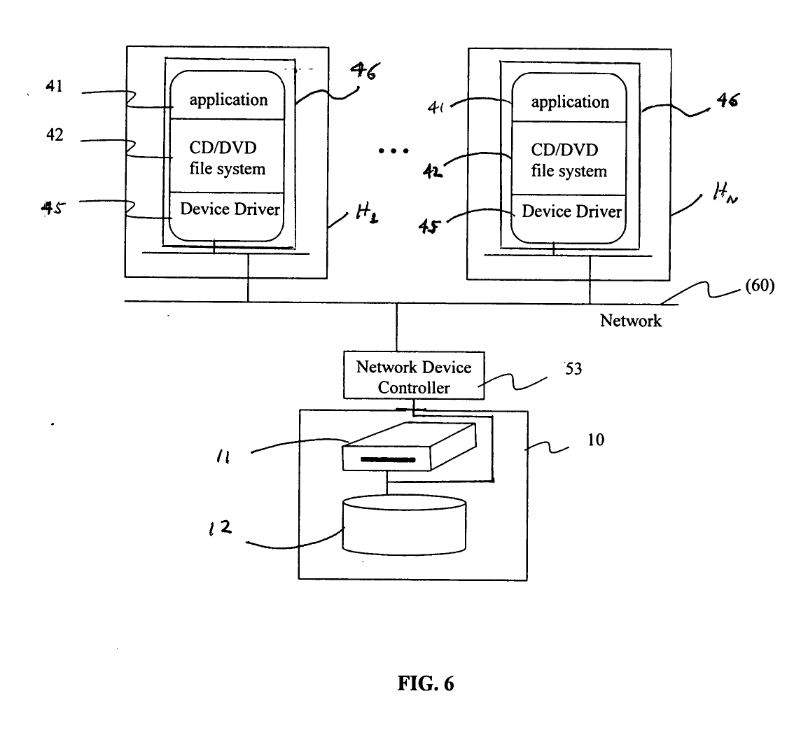

In another embodiment of the present invention illustrated in FIG. 6, a virtual jukebox 10 is coupled to a network 60 through a network device controller 53 so that multiple hosts H₁-H_{N} connected to the network 60 may concurrently access the virtual jukebox 10. The network 60 may be either a wired or wireless network. Hosts H₁-H_{N} may be any combination of personal computers, workstations, set-top boxes, or other hosts as described above. Similar to the system of FIG. 4, software on a host H₁-H_{N} typically includes an application 41 (or several different applications 41) and conventional CD/DVD file system software 42 with a device driver stack 45. Unlike the system of FIG. 4, however, the device driver stack 45 accepts commands from the application 41 by way of the file system 42 intended for the virtual CD/DVD drives 21, 22, 23, and translates them into network commands (as opposed to disk drive commands, as is done in the embodiment of FIG. 4). These network commands are then to be transmitted via the network 60 to the network device controller 53. The network device controller 53 then transforms the network commands into the native interface of the hard disk drive 12 of the virtual jukebox 10. One example of a network device controller 53 allowing direct attachment of a storage device, such as the virtual jukebox 10, is described in U.S. Provisional Application No. 60/603,917, entitled “A Network Direct Attached Storage Suitable for Home Network,” filed Aug. 23, 2004, which is hereby incorporated by reference in its entirety.

One example of a system providing direct access over a network by a host to a storage device, such as a hard disk drive, is provided in U.S. patent application Ser. No. 09/974,082, entitled “Disk System Adapted to Be Directly Attached to Network,” filed Oct. 9, 2001, which is hereby incorporated by reference in its entirety. An example of a method for coupling I/O devices, such as disk drives of various types, to hosts over a network is described in U.S. patent application Ser. No. 10/195,817, entitled “Scheme for Dynamically Connecting I/O Devices Through Network,” filed Jul. 15, 2002, hereby incorporated by reference in its entirety. In addition, a network protocol allowing communication between a host and a network-attached storage device is discussed in U.S. Provisional Application No. 60/590,722, entitled “Low Level Communication Layers and Device Employing Same,” filed Jul. 22, 2004, hereby incorporated by reference in its entirety. The network communications protocol and/or network coupling disclosed in these applications may be employed by the present embodiment to couple the hosts H₁-H_{N} and virtual jukebox 10.

Using the embodiment of FIG. 6, the virtual jukebox 10 may accept and process multiple commands from multiple hosts H₁-H_{N} by providing data, such as multimedia content, stored on the hard disk drive 12 of the virtual jukebox 10 to the hosts H₁-H_{N}, either synchronously or asynchronously. Typically, asynchronous communication over a network 60 involves short data transfers, such as a hard disk data sector, wherein the receipt of each data transfer is acknowledged. Synchronous communications allow transmission of relatively longer data transfers between acknowledgements, normally resulting in faster overall data rates. Providing the data in either fashion is possible due to the typical higher data transfer rates and lower access times associated with the hard disk drive 12. Normally, direct data transfers from a CD/DVD disc by way of a CD/DVD drive, as is employed in a standard jukebox, are slower and involve more lengthy access times, thus making the servicing of data transfer requests from multiple hosts problematic at best.

Also, since the virtual jukebox 10 is viewed logically as multiple CD/DVD drives, each of the multiple hosts H₁-H_{N} coupled with the virtual jukebox 10 over the network 60 may concurrently access separate virtual CD/DVD drives 21, 22, 23 without regard for any other accesses that may be occurring between the hard disk drive 12 and the other hosts H₁-H_{N}.

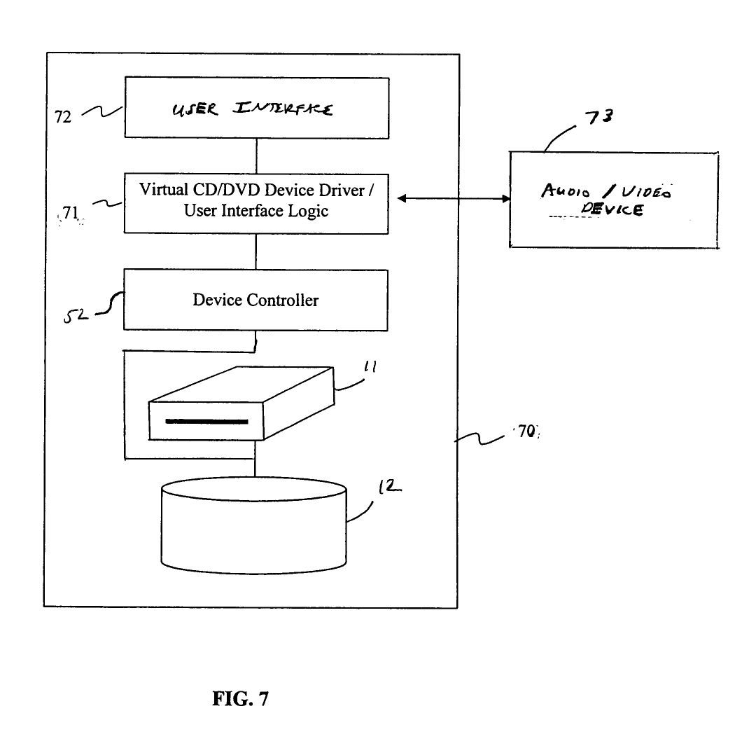

Referring to FIG. 7, in another embodiment of the present invention, a standalone virtual jukebox 70 also employs a CD/DVD drive 11 and a hard disk drive 12, whereby the contents of a disc loaded into the CD/DVD drive 11 are loaded onto the hard disk drive 12, as described above. In addition, a virtual CD/DVD device driver 71, possibly combined with user interface logic, is employed in lieu of the device driver stack of 43 of FIG. 4. Instead of accepting and redirecting commands to a virtual CD/DVD drive from an application by way of a file system, the device driver/user interface logic 71 accepts commands from a user interface 72, such as a touch pad, keypad, touch screen, remote control or other user input device. These commands are translated to a form recognizable by a device controller 52, (similar to that shown in FIG. 4), which controls the operation of the CD/DVD drive 11. The user interface 72 may also include a user output device (not shown), such as a monitor, liquid crystal diode (LCD) display, or other means for relaying the current operation, status, and other pertinent information to a user regarding the standalone virtual jukebox 70. The device driver/user interface logic 71 may also be coupled with an audio and/or video device 73 to reproduce any audio and/or video content, such as music or movies, represented by information read from the hard disk drive 12 that was previously loaded from a disc 13. A standalone virtual jukebox 71 according to an embodiment of the invention would thus be useful in environments not requiring a separate host device, such as part of a home entertainment system, or within a mobile environment, such as an automobile, bus, airplane, or the like.

Disclosed herein are several embodiments of a virtual removable media jukebox capable of providing enhanced performance while requiring fewer mechanical components than a standard jukebox configuration. While these embodiments are described in specific terms, other embodiments encompassing principles of the invention are also possible. For example, various features of one embodiment may be combined with features of other embodiments to create a new embodiment not specifically discussed herein. Also, other types of removable media storage other than CDs and DVDs, such as magneto-optical storage media, magnetic floppy disks, ZIP® drive media, memory keys, and so on, may serve as the basis for a virtual jukebox according to alternative embodiments of the invention. Thus, the scope of the invention is not to be limited to the disclosed embodiments, but is determined by the following claims.

1. A virtual multiple removable media jukebox, comprising:
a host;
a removable media drive in communication with the host;
a hard disk drive in communication with the removable media drive and the host, the hard disk drive storing a datum received from the removable media drive;
a driver operative to provide access for the host to the datum stored on the hard disk drive by presenting to the host a logical view of a virtual removable media drive loaded with the datum;
wherein the removable media drive is configured to store to the hard disk drive the data contents of a removable medium loaded into the removable media drive.

2. The virtual multiple removable media jukebox of claim 1, wherein the hard disk drive communicates with the host by way of a device controller coupled with a system bus of the host.

3. The virtual multiple removable media jukebox of claim 1, wherein the hard disk drive communicates with the host by way of a network.

4. The virtual multiple removable media jukebox of claim 1, wherein the data content of each removable medium loaded into the removable media drive is stored in a mutually exclusive group of sectors of the hard disk drive.

5. The virtual multiple removable media jukebox of claim 4, wherein each mutually exclusive group of sectors is contiguous.

6. The virtual multiple removable media jukebox of claim 1, wherein the removable medium is chosen from the group comprising: a compact disc and a digital versatile disc.

7. The virtual multiple removable media jukebox of claim 1, further comprising a data compressor configured to compress the data content from the removable medium loaded in the removable media drive prior to storing the data content on the hard disk drive.

8. A host, comprising:
a processor;
a removable media drive; and
a hard disk drive in communication with the removable media drive and in communication with the processor;
wherein the removable media drive is configured to store to the hard disk drive the data contents of a removable medium loaded into the removable media drive; and
wherein the hard disk drive provides access by the processor to the data contents stored on the hard disk drive from the removable medium by presenting to the processor a logical view of a virtual removable media drive loaded with the removable medium.

9. The host of claim 8, further comprising a device driver executable on the processor, the device driver configured to translate commands received from a file system of the host intended for a virtual removable media drive to the hard disk drive.

10. The host of claim 8, further comprising a device controller in communication with the hard disk drive and the processor, the device controller configured to map commands from the processor to commands associated with a disk-related interface.

11. The host of claim 8, wherein the removable medium comprises a compact disc.

12. The host of claim 8, the host further comprising:
a first enclosure encompassing the processor; and
a second enclosure encompassing the removable media drive and the hard disk drive.

13. A networked system, comprising:
at least one host;
a network coupled with the at least one host;
a removable media drive; and
a hard disk drive in communication with the removable media drive and in communication with the network;
wherein the removable media drive is configured to store to the hard disk drive the data contents of a removable medium loaded into the removable media drive; and
wherein the hard disk drive provides access by the at least one host to the data contents stored on the hard disk drive from the removable medium by presenting to the at least one host a logical view of a virtual removable media drive loaded with the removable medium.

14. The networked system of claim 13, the host comprising:
a processor; and
a device driver executable on the processor, the device driver configured to translate commands received from a file system of the host intended for a virtual removable media drive to the hard disk drive.

15. The networked system of claim 13, wherein communication between the at least one host and the hard disk drive is asynchronous.

16. The virtual multiple removable media jukebox of claim 13, wherein the removable medium is chosen from the group comprising: a compact disc and a digital versatile disc.

17. The virtual multiple removable media jukebox of claim 16, further comprising a data compressor configured to compress the data content from the removable medium loaded in the removable media drive prior to storing the data content on the hard disk drive.

18. A standalone virtual multiple removable media jukebox, comprising:
a user interface;
a removable media drive;
a hard disk drive in communication with the removable media drive and in communication with the device controller;
wherein the removable media drive is configured to store to the hard disk drive the data contents of a removable medium loaded into the removable media drive; and
wherein the hard disk drive provides access by the user interface to the data contents stored on the hard disk drive from the removable medium by presenting to the user interface a logical view of a virtual removable media drive loaded with the removable medium.

19. The standalone virtual multiple removable media jukebox of claim 18, further comprising a device controller in communication with the user interface and the hard disk drive, the device controller mapping commands originating from the user interface to a disk-related interface employed by the hard disk drive.

20. The standalone virtual multiple removable media jukebox of claim 19, further comprising a combined device driver and user interface logic in communication with the user interface and the device controller, the combined device driver and user interface logic configured to translate commands from the user interface into a form understandable by the device controller.

21. The standalone virtual multiple removable media jukebox of claim 18, the user interface comprising a user input device selected from the group consisting of a touch pad, a keypad, a touch screen, and a remote control.

22. The standalone virtual multiple removable media jukebox of claim 20, further comprising an audio device coupled with the combined device driver and user interface logic, the audio device being configured to reproduce audio content represented by the data content stored on the hard disk drive.

23. A method for providing content of a removable media, comprising:
reading data content of a removable medium;
storing a copy of the data content from the removable medium on a hard disk drive; and
upon request for access to the data content of the removable medium, providing access to the copy of the data content stored on the hard disk drive by way of a logical view of the data content as stored on the removable medium.

24. The method of claim 23, wherein the access to the data content allowed by the providing step is read access.

25. The method of claim 23, wherein the access to the data content allowed by the providing step is write access.

26. The method of claim 23, further comprising compressing the copy of the data content stored on the hard disk drive in comparison to the data content of the removable medium.

27. The method of claim 23, wherein the copy of the data content is accessed in the access providing step by a host via a system bus of the host.

28. The method of claim 23, wherein the copy of the data content is accessed in the access providing step by a host via a network.

29. The method of claim 23, wherein the copy of the data content is accessed in the access providing step by a user interface, the user interface comprising a user input device selected from the group consisting of a touch pad, a keypad, a touch screen, and a remote control.
